(19) United States
(12) Patent Application Publication
(10) Pub. No.: US 2026/0208975 A1
(43) Pub. Date: Jul. 23, 2026

(54) BUFFER DEVICE CONFIGURED TO BUFFER CONTAINERS IN A PRE-GROUPED ARRANGEMENT ON A BUFFER SURFACE OF THE BUFFER DEVICE, AND METHOD FOR BUFFERING CONTAINERS IN A PRE-GROUPED ARRANGEMENT USING THE BUFFER DEVICE

(71) Applicant: Krones AG, Neutraubling (DE)

(72) Inventors: Michael NEUBAUER, Grassau (DE); Stefan ELSPERGER, Söchtenau (DE)

(21) Appl. No.: 19/455,746

(22) Filed: Jan. 21, 2026

(30) Foreign Application Priority Data
Jan. 22, 2025 (DE) 102025102164.3

(51) Int. Cl. B65G 47/82; B65G 43/08

(52) U.S. Cl. CPC B65G 47/82; B65G 43/08

(57) ABSTRACT

A buffer device configured to buffer containers, such as bottles, in a pre-grouped arrangement on a buffer surface of the buffer device, wherein the buffer device comprises paddles which are configured to move containers on the buffer surface in one direction and which extend in a second direction transverse to the first direction completely or at least to 90% over the extent of the buffer surface. A method includes buffering containers, such as bottles, in a pre-grouped arrangement using the buffer device.

### CROSS-REFERENCE TO RELATED APPLICATION AND PRIORITY CLAIM

This application claims priority to German Patent Application No. 10 2025 102 164.3, filed January 22, 2025, the disclosure of which is incorporated herein by reference in its entirety.

### TECHNICAL FIELD

The invention relates to a buffer device configured to buffer containers in a pre-grouped arrangement on a buffer surface of the buffer device and to a method for buffering containers in a pre-grouped arrangement using the buffer device.

### BACKGROUND

It is known to be used mass transport belts, for example, for buffering containers, such as bottles or cans. The grouping of containers for subsequent packaging takes place in a separate process at an infeed of the packer, where the grouped containers are packed. The infeed to the packer can be prone to malfunctions, as the containers are forced into narrow lanes, wherein damage to the containers due to pressure and friction forces, for example, cannot be ruled out. The containers are then grouped using the dividing fingers of a dividing device. This can frequently lead to containers falling over. Furthermore, the dividing device can be prone to errors, and precise configuration and adjustment are essential for reliable operation. When changing the format of the containers, the dividing fingers must be replaced.

### SUMMARY

The object of the invention is to provide a buffer device and a method for buffering using the buffer device, which can enable space-saving and individually controllable buffering.

The problem is solved by the buffer device configured to buffer containers in a pre-grouped arrangement on a buffer surface of the buffer device and by the method for buffering containers in a pre-grouped arrangement using the buffer device.

The buffer device according to the invention is configured to buffer containers, such as bottles, in a pre-grouped arrangement on a buffer surface of the buffer device, wherein the buffer device comprises paddles which are configured to move containers on the buffer surface in one direction and which extend in a second direction transverse to the first direction completely or at least to 90% over the extent of the buffer surface.

Containers are in a pre-grouped arrangement if they are recognizably arranged in groups by their respective distances from each other. For example, there are containers that are further away from a container moving ahead in a given direction than from a container following in that direction, or that are in contact with the container following in that direction (beginning of the group). Optionally, there are containers that are the same distance from a container arranged ahead in the direction of view and a container arranged behind in the direction of view, or that are in contact with both containers (containers within the group), and containers that are further away from a container arranged behind in the direction of view than from a container arranged ahead in the direction of view, or that are in contact with the container arranged ahead in the direction of view (end of the group). Container groups with only two containers in the direction of view have no containers within the group. Container groups with three or more containers have one or more containers within the group. Such groups can occur multiple times in succession in the direction of view

One direction can be in the y-direction. The paddles can extend in the x-direction (second direction) and can be configured to be movable in the y-direction.

The buffer device makes it possible to integrate the grouping of containers into the buffering process.

The buffer device can further comprise at least one long stator linear motor arranged upstream of the buffer surface with individually controllable shuttles arranged on it. Each shuttle can be configured to accommodate a container that can be slid from the shuttle onto the buffer surface.

The shuttles can be used to arrange containers in a pre-grouped arrangement before or while they are moved to the buffer surface in the pre-grouped array.

The buffer device can further comprise at least one single-track transport belt for transporting containers to the at least one long stator linear motor. For example, the buffer device can further comprise at least one detection device, such as a light barrier or camera, for detecting the positions of the containers on the at least one single-track transport belt. The detected positions of the containers can be used to control the shuttles and synchronize them with the containers.

The buffer device may further comprise a control device for controlling the shuttles. For example, the control device can be configured to synchronize the shuttles with the detected positions of the containers. For example, the control device can be further configured to group the shuttles according to the desired pre-grouped arrangement of the containers.

The buffer device may further comprise at least one transfer device which may be configured to push containers from the at least one single-track transport belt onto the synchronized shuttles. For example, the transfer device can be a transfer plate or a transfer belt.

The transfer device can push containers from the transport belt onto individually controllable shuttles. The shuttles can be arranged on a revolving long stator linear motor. The controllability allows the position of a shuttle on the long stator linear motor to be changed by moving the shuttle. The shuttles can be controlled in such a way that they can be synchronized to the position of the containers detected by the detection device, making it possible to transfer a container from the transport belt onto a shuttle.

The paddles can be configured to push containers across the buffer surface. For example, the paddles can be further developed to push containers from the shuttles in the pre-grouped arrangement onto the buffer surface.

To maintain the pre-grouped arrangement, lane plates or clamping mechanisms may be provided in the area of the buffer surface. For example, the lane plates can be configured to be interchangeable or adjustable in order to be able to buffer containers of different dimensions in the buffer device. The lane plates can run in the y-direction. A lane can be delimited on both sides by a lane plate. The lane plates can facilitate the maintenance of the pre-grouped arrangement of the containers when they are pushed across the buffer surface by paddles.

If lane plates are provided, the paddles can comprise cutouts for the lane plates so that the paddles can still be moved in the y-direction.

The buffer device can comprise four of the long stator linear motors. Such an embodiment of the buffer device may be suitable for higher machine outputs.

The buffer device can then comprise four single-track transport belts, each of which can transport vertically arranged containers in a first transport direction. For example, containers can be fed to the four transport belts by two upstream machines, wherein two switches can be provided that can operate alternately. This allows the first switch to transfer containers to the first and second transport belts and the second switch to transfer containers to the third and fourth transport belts.

To detect the positions of the containers on the four single-track transport belts, a detection device can be provided for each of the transport belts, i.e., a total of four detection devices for the buffer device, such as a light barrier or a camera.

Each of the single-track transport belts can be equipped with a transfer device, for example a transfer plate or a transfer belt, which can each be configured to push containers from the assigned transport belt onto the individually controllable shuttles. The shuttles can each be arranged on one of the four revolving long stator linear motors. The controllability allows the position of one of the shuttles on one of the corresponding long stator linear motors to be changeable by moving the respective shuttle. The shuttles can each be controlled in such a way that they can be synchronized to the position of the containers detected by the detection devices, so that it is possible to transfer a container from one of the transport belts to a corresponding shuttle.

In order to buffer the containers on the buffer surface of the buffer device in the aforementioned pre-grouped arrangement, the shuttles are controlled after synchronization and the transfer of the containers onto the shuttles, in order to group the shuttles according to the pre-grouped arrangement of the containers.

For example, a control device can be provided for each long stator linear motor to control the shuttles, wherein the control devices are configured to synchronize the shuttles with the detected positions of the containers and to group the shuttles according to the pre-grouped arrangement of the containers.

At the outlet of the buffer surface (an end area of the buffer surface), a servo tension system can be arranged, which can comprise several independently movable platforms for receiving containers in the pre-grouped arrangement. For example, a push rod may be provided which may be configured to plunge into gaps between groups of the pre-grouped arrangement and push containers in the pre-grouped arrangement off the platform. For example, the platforms can have a length that corresponds to the length of the buffer surface. For example, the width of the platform can be configured to accommodate several rows of containers from the buffer surface. The number of rows of containers can depend on the number of infeed lanes of a subsequent packer in which the pre-grouped containers, for example in bundles, are to be packed. For example, a pre-grouped arrangement of containers can comprise three containers in each case, wherein, for example, eight pre-grouped arrangements (i.e., eight times three containers) can be provided in a row of containers. For example, six such rows of containers can be arranged on one platform for a packer with six infeed lanes. For example, using the pre-grouped containers provided by the platform, 24 bundles can be packed into 2 x 3 containers without any further regrouping.

The platforms allow the containers to be transported in a third direction (x-direction). The containers can be pushed from the buffer surface onto one of the platforms using the paddles. The platforms can be configured to be controllable so that they can be synchronized with containers being pushed from the buffer surface.

The platforms allow the grouped containers to be fed to a packer, for example. Using the push rod, containers in the pre-grouped arrangement can be pushed from the platform, for example, into an infeed lane of the packer. The grouped containers can then be packed in the packer in that grouping. To return to the previous numerical example, it can be provided that, with eight pre-grouped arrangements of three containers each and six such rows of containers arranged on a platform, the push rod plunges into a gap between, viewed in the third transport direction, the first groups of three of the six rows of containers and the second groups of three of the six rows of containers. The push rod can then push the first groups of three from the six rows of containers into the six infeed lanes of the packer. The same procedure can be followed with the remaining groups of three until all containers have been pushed from the platform into the infeed lanes of the packer.

The shuttles can be configured in such a way that they can be nested inside one another. Such shuttles are suitable, for example, when containers of different sizes need to be buffered on the buffer device. In this context, first shuttles can have first comb-like fingers on two opposite sides, and second shuttles can have second comb-like fingers on two opposite sides, wherein the first comb-like fingers and the second comb-like fingers can each be configured in such a way that they can be pushed into one another.

Furthermore, a method for buffering containers, such as bottles, in a pre-grouped arrangement using the buffer device as described above or below is provided.

The method can comprise transporting containers to the at least one long stator linear motor by the at least one single-track transport belt.

The method may comprise detecting the positions of the containers on the at least one single-track transport belt using the detection device.

The method can comprise controlling the shuttles and synchronizing the shuttles with the detected positions of the containers.

The method can comprise pushing the containers from the single-track transport belt onto the synchronized shuttles using the transfer device. For example, the method can comprise moving the shuttles to the buffer surface using the long stator linear motor and controlling the shuttles to group them according to the pre-grouped arrangement.

The method can comprise braking the shuttles and pushing the containers from the shuttles onto the buffer surface in the pre-grouped arrangement using the paddles. For example, the method can comprise pushing the containers over the buffer surface using the paddles and, for example, pushing the containers onto the platform in the pre-grouped arrangement using the paddles and, for example, moving the platform to an unloading position using the servo tension system, plunging the push rod into gaps between the pre-grouped arrangement, and pushing the containers off the platform in the pre-grouped arrangement.

The unloading position can be an infeed lane of a packer where the containers are to be packed in the pre-grouped arrangement.

### BRIEF DESCRIPTION OF THE DRAWINGS

The accompanying drawings show, by way of example, aspects and/or exemplary embodiments of the invention for better understanding and illustration. In the drawings:

FIG. 1 shows a first schematic view of a first embodiment of a buffer device for buffering containers in a pre-grouped arrangement on a buffer surface (some elements of the buffer device are not shown),

FIG. 2 shows a second schematic view of the first embodiment of the container buffer device,

FIG. 3 shows a schematic view of a second embodiment of a buffer device for buffering containers in a pre-grouped arrangement on a buffer surface of the buffer device,

FIG. 4 shows a plan view of the second embodiment with containers arranged in the buffer device, and

FIG. 5 shows a schematic plan view of an embodiment of the shuttle.

### DETAILED DESCRIPTION

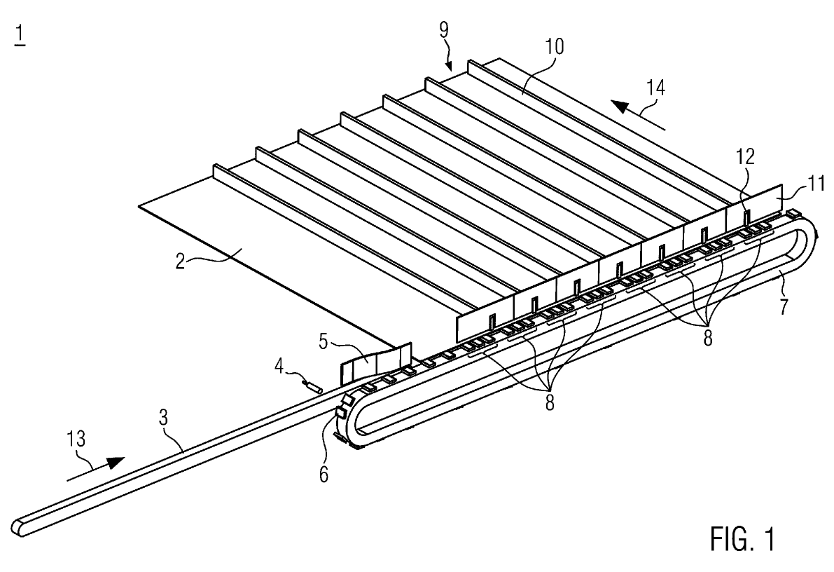

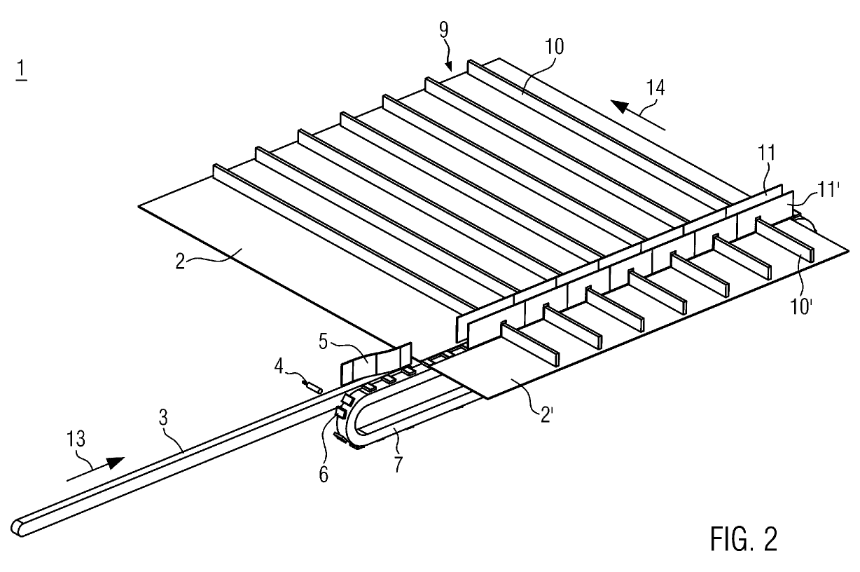

FIG. 1 shows a first schematic view of a first embodiment of a buffer device 1 for buffering containers in a pre-grouped arrangement on a buffer surface 2 of the buffer device 1. For clarity, some elements of the buffer device 1 have been omitted here (see FIG. 2 for a detailed schematic view).

The buffer device 1 comprises a transport belt 3, with which upright containers can be transported in a first transport direction 13 (x-direction).

A detection device 4, such as a light barrier or a camera, is provided for detecting the positions of the containers on the single-track transport belt 3.

The buffer device 1 further comprises a transfer device 5, for example a transfer plate or a transfer belt, which is configured to push containers from the transport belt 3 onto individually controllable shuttles 6. The shuttles 6 are arranged on a revolving long stator linear motor 7. The controllability allows the position of a shuttle 6 on the long stator linear motor 7 to be changed by moving the shuttle 6. The shuttles 6 can be controlled in such a way that the shuttles 6 can be synchronized to the positions of the containers detected by the detection device 4, so that it is possible to slide a container from the transport belt 3 onto a shuttle 6. It may be planned that a single container is provided per Shuttle 6.

In order to buffer the containers on the buffer surface 2 of the buffer device 1 in the aforementioned pre-grouped arrangement, the shuttles 6 are controlled after synchronization and the transfer of the containers in order to arrange the shuttles 6 in a grouped manner according to the pre-grouped arrangement of the containers. The pre-grouped arrangement can be predetermined, for example taking into account planned packaging in a packer downstream of the buffer device 1.

For example, a control device (not shown) can be provided to control the shuttles 6, wherein the control device can be configured to synchronize the shuttles with the detected positions of the containers and to group the shuttles according to the pre-grouped arrangement of the containers.

FIG. 1 shows eight groups 8 of shuttles 6 arranged in groups of three shuttles 6 each. These eight groups 8 are arranged on the long stator linear motor 7 in front of lanes 9 that run along the buffer surface 2 in the y-direction. A lane 9 can be delimited on at least one side or on both sides by a lane plate 10. The lane plates 10 run in the y-direction. The lane plates 10 can facilitate the maintenance of the pre-grouped arrangement of the containers when they are pushed over the buffer surface 2 by paddles 11. The lane plates 11 can be configured to be interchangeable or adjustable in order to buffer containers of different dimensions in the buffer device 1. Clamping mechanisms can be provided instead of the lane plates 11.

In FIG. 1, only one paddle 11 is shown. To allow it to be moved in the y-direction, it comprises cutouts 12 for the lane plates 10. In the illustration, this paddle 11, viewed in the y-direction, could push containers arranged behind it on the buffer surface 2 into a second transport direction 14 (y-direction) and thus to an end area of the buffer surface 2.

Following the end area of the buffer surface 2, another transport belt can be provided for conveying away the grouped containers that have been pushed onto it from the buffer surface 2. For example, the grouped containers can be fed to a packer, and in the packer the grouped containers can be packed in this grouping.

FIG. 2 shows a second schematic view of the first embodiment of the buffer device 1, wherein some of the elements that have been omitted from FIG. 1 for the sake of clarity are shown.

The elements are a second paddle 11', which, viewed in the first transport direction 13, is arranged on the right hand of the shuttles 6 or the long stator linear motor 7 and is therefore suitable for pushing containers located on the shuttles 6 onto the buffer surface 2 when moving in the y-direction. In addition, in the first transport direction 13, to the right of the shuttles 6 or the long stator linear motor 7, another part of buffer surface 2' with lane plates 10' running in the y-direction is shown.

No lane plates are provided in the area between the shuttles, i.e., above the long stator linear motor 7.

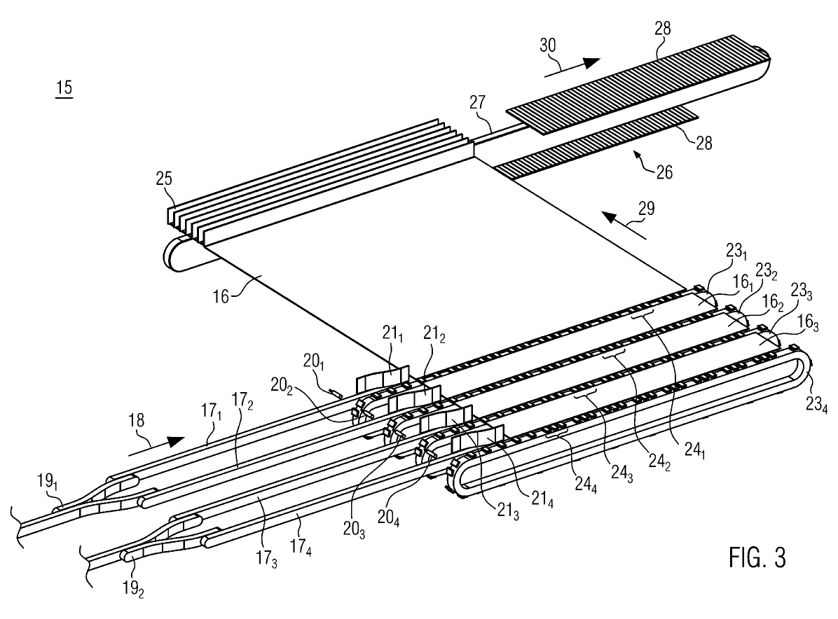

FIG. 3 shows a schematic view of a second embodiment of a buffer device 15 for buffering containers in a pre-grouped arrangement on a buffer surface 16 of the buffer device 15. This second embodiment is suitable, for example, for higher machine outputs.

The buffer device 15 comprises four single-track transport belts 171, 172, 173, 174, with which containers arranged upright can be transported in a first transport direction 18 (x-direction). The four transport belts 171, 172, 173, 174 can be fed, for example, from two machines arranged upstream, wherein two switches 191, 192 are provided to alternately divide the container flows. Thus, the first switch 191 can transfer containers to the first and second transport belts 171, 172 and the second switch 192 can transfer containers to the third and fourth transport belts 173, 174.

For detecting the positions of the containers on the single-track transport belts 171, 172, 173, 174, a detection device 201, 202, 203, 204, such as a light barrier or a camera, is provided for each of the transport belts 171, 172, 173, 174.

Furthermore, for each of the single-track transport belts 171, 172, 173, 174 there is a transfer device 211, 212, 213, 214 provided, for example, a transfer plate or a transfer belt, each configured to push containers from the associated transport belt 171, 172, 173, 174 on individually controllable shuttles 221, 222, 223, 224. The shuttles 221, 222, 223, 224 are each arranged on one of four revolving long stator linear motors 231, 232, 233, 234. As a result of the controllability, the position of one of the shuttles 221, 222, 223, 224 on one of the corresponding long stator linear motors 231, 232, 233, 234 is changeable by a movement of the respective shuttle 221, 222, 223, 224. The shuttles 221, 222, 223, 224 can be controlled in such a way that the shuttles 221, 222, 223, 224 can be synchronized with the position of the containers detected by the detection devices 201, 202, 203, 204 so that it is possible to transfer a container from one of the transport belts. 171, 172, 173, 174 onto a corresponding shuttle 221, 222, 223, 224. It may be provided that a single container is provided per shuttle 221, 222, 223, 224.

In order to buffer the containers on the buffer surface 16 of the buffer device 15 in the aforementioned pre-grouped arrangement, the shuttles 221, 222, 223, 224 are controlled after synchronization and the transfer of the containers in order to arrange the shuttles 221, 222, 223, 224 in a grouped manner according to the pre-grouped arrangement of the containers. The pre-grouped arrangement can be predetermined, for example taking into account planned packaging in a packer downstream of the buffer device 15.

For example, one control device (not shown) per long stator linear motor 231, 232, 233, 234 can be provided to control the shuttles 221, 222, 223, 224, wherein the control devices may be configured to synchronize the shuttles 221, 222, 223, 224 with the detected positions of the containers and to arrange the shuttles 221, 222, 223, 224 in a grouped manner according to the pre-grouped arrangement of the containers.

FIG. 3 shows eight groups 241, 242, 243, 244 of shuttles 221, 222, 223, 224 arranged in groups of three shuttles each 221, 222, 223, 224. Between the first long stator linear motor 231 and the second long stator linear motor 232 there is arranged another buffer surface 161 so that containers can be transferred from shuttles 222, 223, 224 of the second, third and fourth long stator linear motors 232, 233, 234. Between the second long stator linear motor 232 and the third long stator linear motor 233 is arranged another buffer surface 162 so that containers can be transferred from shuttles 223, 224 of the third and fourth long stator linear motors 233, 234. Between the third long stator linear motor 233 and the fourth long stator linear motor 234 there is arranged another buffer surface 163 so that containers can be transferred from shuttles 224 of the fourth long stator linear motor 234. The transfer takes place in a second transport direction 29 (y-direction). Of the 25 paddles intended for transferring the containers, seven are shown in the end area of the buffer surface 16. The paddles 25 are movable in the y-direction. The paddles 25 can be individually controllable and circulating.

The servo tension system 26 shown can be arranged following the end area of the buffer surface 16, i.e., in an outlet of the buffer surface 16. Several independently movable platforms 28 for receiving containers are arranged in the pre-grouped arrangement on a revolving endless belt 27. Using the platforms 28, the containers can be transported in a third transport direction 30 (x-direction). The platforms 28 can have a width that allows several rows of containers to be received from the buffer surface 16. The containers can be pushed from the buffer surface 16 onto a platform 28 using the paddles 25. The platforms 28 can be configured to be controllable so that they can be synchronized with containers to be pushed from the buffer surface 16.

Platform 28 allows the grouped containers to be fed to a packer. For example, a push rod (not shown) may further be provided and may be configured to plunge into gaps between the groups of pre-grouped containers and may push containers in the pre-grouped arrangement from the platform 28, for example, into an infeed lane of the packer. The grouped containers can then be packed in the packer in that grouping.

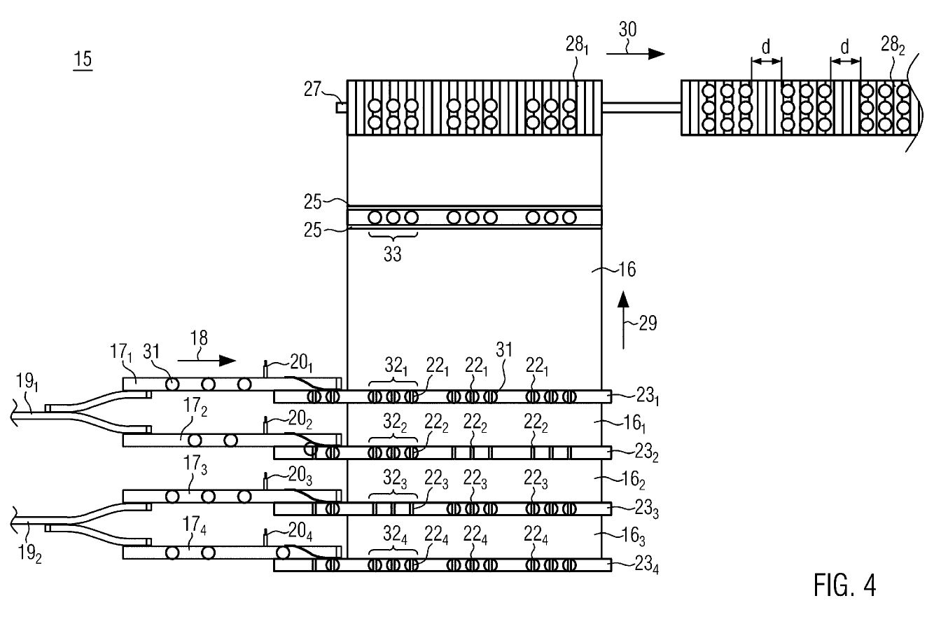

FIG. 4 shows a plan view of the second embodiment with containers 31 arranged in the buffer device 15.

Each upright container 31 is transported on the four single-track transport belts 171, 172, 173, 174 in the first transport direction 18 (x-direction). The positions of the containers 31 on the single-track transport belts 171, 172, 173, 174 are detected by the respective detection devices 201, 202, 203, 204 of the transport belts 171, 172, 173, 174.

The containers 31 are pushed by the corresponding transfer devices 211, 212, 213, 214 from the assigned transport belts 171, 172, 173, 174 to corresponding shuttles 221, 222, 223, 224 of the individually controllable shuttles 221, 222, 223, 224. The shuttles 221, 222, 223, 224 are controlled in such a way that the shuttles 221, 222, 223, 224 are synchronized with the positions of the containers 31 detected by the detection devices 201, 202, 203, 204, so that it is possible to transfer a container 31 from one of the transport belts 171, 172, 173, 174 onto a corresponding shuttle 221, 222, 223, 224.

In order to buffer the containers 31 on the buffer surface 16 of the buffer device 15 in the aforementioned pre-grouped arrangement, the shuttles 221, 222, 223, 224 are controlled after synchronization and the transfer of the containers onto the shuttles 221, 222, 223, 224 in order to arranged the shuttles 221, 222, 223, 224 in a grouped manner according to the pre-grouped arrangement of the containers 31. The illustration of FIG. 4 shows three groups 321, 322, 323, 324 of shuttles 221, 222, 223, 224 arranged in groups of three shuttles each 221, 222, 223, 224.

In the first long-stator linear motor 231, containers 31 are located on all shuttles 221 of the three groups. In the second long stator linear motor 232, containers 31 are located on the shuttles 222 of the first group, and no containers are located on the shuttles 222 of the second and third groups. In the third long stator linear motor 233,no containers are located on the shuttles 223 of the first group, and containers 31 are located on the shuttles, 223 of the second and third groups. In the fourth long stator linear motor 234 containers 31 are located on all shuttles 224 of the three groups.

With this arrangement of containers 31 on the shuttles 221, 222, 223, 224, the containers 31 of the third long stator linear motor 233 can first be pushed onto the free shuttle 222 of the second long stator linear motor 233.

On the buffer surface, three groups 33 of pre-grouped containers 31 are arranged between two paddles 25 in order to push them across the buffer surface 16 to the servo tension system 26 and then onto a platform 28, for example onto the first platform 281 of the servo tension system 26.

The first platform 281 in the illustration is located at the end area of the buffer surface 16, and two rows of containers 31, in each case in groups of three, have already been pushed onto the first platform from the buffer surface 16 by the paddles 25.

Three rows of containers, in each case in groups of three, are arranged on the second platform 282. The packer, not shown, can comprise three infeed lanes in which the pre-grouped containers 31 can be packed, for example in bundles. Based on the pre-grouped containers 31 arranged on the second platform 282, three bundles, for example, can be packed into 3 x 3 containers without any further regrouping.

The platforms 28 of the servo tension system can be loaded one after the other with several rows of containers. Alternatively, several rows of containers 31 can be simultaneously pushed onto a platform 28.

Between each of the adjacent groups of three there is a distance d, i.e., a gap, into which a push rod can plunge and push the containers 31 in the pre-grouped arrangement from the second platform 282, for example, into the infeed lanes of the packer. First, the push rod can plunge into a gap between, seen in the third transport direction 30, the first groups of three of the three rows of containers and the second groups of three of the three rows of containers. The push rod can then push the first groups of three of the three rows of containers into the three infeed lanes of the packer, where a first bundle of 3 x 3 containers is packed. Then, the push rod can plunge into a gap between, seen in the third transport direction 30, the second groups of three (now the first are on the platform) of the three rows of containers and the third groups of three (now the second are on the platform) of the three rows of containers. The push rod can then push the second groups of three into the three infeed lanes of the packer, where a second bundle of 3 x 3 containers can be packed. Finally, the push rod can push the third groups of three (now the first on the platform) into the three infeed lanes of the packer, where a third bundle of 3 x 3 containers can be packed.

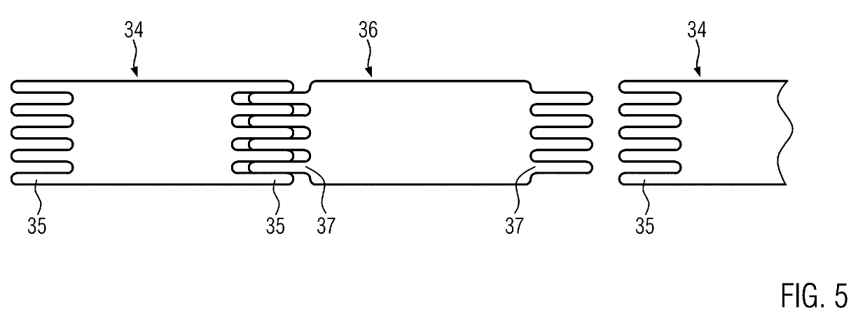

FIG. 5 shows a schematic plan view of an embodiment of the shuttles 34, 36. The first shuttles 34 in this case have first comb-like fingers 35 on two opposite sides and the second shuttles 36 have second comb-like fingers 37 on two opposite sides, wherein the first comb-like fingers 35 and the second comb-like fingers 37 are each configured in such a way that they can be pushed into one another. Such shuttles 34, 36 are suitable, for example, if containers of different sizes are to be used for the buffer devices 1, 15.

What is claimed is:

1. A buffer device configured to buffer containers in a pre-grouped arrangement on a buffer surface of the buffer device, the buffer device comprising:
paddles configured to move containers on the buffer surface in a first direction, wherein the paddles extend in a second direction transverse to the first direction completely or at least 90% over an extent of the buffer surface.

2. The buffer device of claim 1, further comprising at least one long stator linear motor arranged upstream of the buffer surface with shuttles arranged thereon that are individually controllable, wherein each shuttle is configured to receive a container which can be transferred by the shuttle onto the buffer surface.

3. The buffer device of claim 2, further comprising:
at least one single-track transport belt for transporting containers to the at least one long stator linear motor, and
at least one detection device for detecting positions of the containers on the at least one single-track transport belt.

4. The buffer device of claim 3, wherein the at least one detection device is a light barrier or a camera.

5. The buffer device of claim 3, further comprising a control device for controlling the shuttles, wherein the control device is configured to synchronize the shuttles with the detected positions of the containers, and wherein the control device is further configured to arrange the shuttles in a grouped manner according to the pre-grouped arrangement of the containers.

6. The buffer device of claim 5, further comprising at least one transfer device configured to push containers from the at least one single-track transport belt onto the synchronized shuttles.

7. The buffer device of claim 6, wherein the at least one transfer device is a transfer plate or a transfer belt.

8. The buffer device of claim 5, wherein the paddles are configured to push containers over the buffer surface, and wherein the paddles are further configured to push containers from the shuttles in the pre-grouped arrangement onto the buffer surface.

9. The buffer device of claim 8, wherein, to maintain the pre-grouped arrangement, lane plates or clamping mechanisms are provided in an area of the buffer surface.

10. The buffer device of claim 9, wherein the lane plates are configured to be replaceable or adjustable.

11. The buffer device of claim 2, wherein the at least one long stator linear motor comprises four long stator linear motors.

12. The buffer device of claim 1, wherein a servo tension system is arranged at an outlet of the buffer surface and comprises several independently movable platforms for receiving containers in the pre-grouped arrangement, wherein, for example, a push rod is further provided which is configured to plunge into gaps between groups of the pre-grouped arrangement and to push containers in the pre-grouped arrangement from the several independently movable platforms, wherein the several independently movable platforms have a length that corresponds to a length of the buffer surface, and wherein a width of the several independently movable platforms is configured to receive several rows of containers from the buffer surface.

13. A method for buffering containers in a pre-grouped arrangement on a buffer surface of a buffer device, the method comprising:
moving, using paddles of the buffer device, containers on the buffer surface in a first direction, wherein the paddles extend in a second direction transverse to the first direction completely or at least 90% over an extent of the buffer surface.

14. The method of claim 13, further comprising transporting containers to at least one long stator linear motor of the buffer device by at least one single-track transport belt.

15. The method of claim 14, further comprising detecting positions of the containers on the at least one single-track transport belt by at least one detection device.

16. The method of claim 15, wherein the at least one detection device is a light barrier or a camera.

17. The method of claim 15, wherein the buffer device includes at least one long stator linear motor arranged upstream of the buffer surface with shuttles arranged thereon,
the method further comprising controlling the shuttles and synchronizing the shuttles with the detected positions of the containers.

18. The method according to claim 17, wherein the buffer device further comprises at least one transfer device,
the method further comprising pushing the containers from the single-track transport belt onto the synchronized shuttles by the transfer device, and moving the shuttles using the long stator linear motor to the buffer surface and at a same time controlling the shuttles to group the shuttles according to the pre-grouped arrangement.

19. The method of claim 18, wherein the at least one transfer device is a transfer plate or a transfer belt.

20. The method of claim 18, further comprising:
braking the shuttles and transferring the containers from the shuttles onto the buffer surface in the pre-grouped arrangement by the paddles;
pushing the containers over the buffer surface by the paddles;
pushing the containers onto a platform in the pre-grouped arrangement by the paddles;
moving the platform by a servo tension system to an unloading position;
plunging a push rod into gaps between groups of the pre-grouped arrangement; and
pushing the containers from the platform in the pre-grouped arrangement.
